(19) United States
(12) Patent Application Publication
(10) Pub. No.: US 2025/0000089 A1
(43) Pub. Date: Jan. 2, 2025

(54) SYSTEM AND METHOD FOR SOIL ENHANCEMENT AND VEGETATION MANAGEMENT

(71) Applicant: The Lawn Authority LLC, McKinney, TX (US)

(72) Inventors: Ryan Phillips, McKinney, TX (US); Casey Averitt, Hico, TX (US); Wayne Sledge, Rickreall, OR (US); TJ Justice, McKinney, TX (US)

(21) Appl. No.: 18/342,543

(22) Filed: Jun. 27, 2023

(51) Int. Cl. A01N 33/02; A01N 25/06; A01N 25/30; A01N 31/02

(52) U.S. Cl. CPC A01N 33/02; A01N 25/06; A01N 25/30; A01N 31/02

(57) ABSTRACT

A soil enhancement system and method is configured to eradicate undesirable plant-life while providing enhancing nutrients to the soil. The method includes applying non-toxic acid-based solution to one or more invasive plants in a soil. The method also includes dehydrating, by the non-toxic acid-based solution, the one or more invasive plants by disturbing a water-retaining capacity of a number of cells of the one or more invasive plants. The method further includes generating one or more beneficial nutrients; and delivering the one or more beneficial nutrients to the soil.

### TECHNICAL FIELD

The present disclosure relates to vegetative management. More specifically, this disclosure relates to a system and method for non-toxic acid-based soil enhancement and vegetation management.

### BACKGROUND

A majority of the population occupy a residence with a yard. A recent study for the National Association of Landscape Professionals revealed that 81% of Americans have a lawn. Many Americans further indicate that an attractive yard is an important feature of the home. Many yards suffer from infestation by non-desirable vegetation growth, commonly referred to as “weeds”. Some weeds include: Johnsongrass (Sorghum halepense), dandelions (Taraxacum), crabgrass (Digitaria), white clover (Trifolium repens), ragweed (Ambrosia spp.), chickweed (Stellaria media), Creeping Charlie (Glechoma hederacea), Oxalis (Oxalis stricta), Spotted spurge (Euphorbia maculata), bull thistle (Cirsium vulgare), quackgrass (Elymus repens), and lambsquarter (Chenopodium album). These weeds are invasive and can be detrimental to the soil, grass, desired plant-life, and cattle. For example, Johnsongrass can generate cyanogenic glycosides, which is converted to free cyanide in the rumen in cattle. Additionally, thick Johnsongrass can alter the diversity of an area and alter soil properties due to associations with nitrogen-fixing bacteria.

Certain methods for weed control include applications of solutions including glyphosate. Glyphosate (C₃H₈NO₅P) is a widely used herbicide that inhibits plant growth by blocking an essential growth enzyme and interfering with a specific metabolic pathway. Glyphosate is listed as the active ingredient in ROUNDUP, which has been a very popular weed killer. ROUNDUP is a non-selective herbicide. That is, ROUNDUP is formulated to kill most plants to which it comes in contact. Furthermore, after application to plants, the herbicide further transfers to the soil and can further enter the subsurface water table.

ROUNDUP has been associated as a possible source of cancer in humans. For example, a few studies of farmers and people who work with ROUNDUP have linked the use of Glyphosate to non-Hodgkin lymphoma (a cancer originating in the white blood cells). Other studies have found no connection.

### SUMMARY

The present disclosure illustrates embodiments of a system and method for non-toxic acid-based soil enhancement and vegetation management.

In a first embodiment, a soil enhancement method is provided. The method includes applying non-toxic acid-based solution to one or more invasive plants in a soil. The method also includes dehydrating, by the non-toxic acid-based solution, the one or more invasive plants by disturbing a water-retaining capacity of a number of cells of the one or more invasive plants. The method further includes generating one or more beneficial nutrients; and delivering the one or more beneficial nutrients to the soil.

In a second embodiment, a soil enhancement solution is provided. The soil enhancement solution includes a non-toxic acid-based solution configured to be applied to one or more invasive plants in a soil. The non-toxic acid-based solution is configured to: dehydrate the invasive plants by disturbing a water-retaining capacity of a number of cells of the invasive plants; generate one or more beneficial nutrients; and deliver the beneficial nutrients to the soil.

In a third embodiment, a soil enhancement solution is provided. The soil enhancement solution includes an acid-based compound. The soil enhancement solution further includes a non-ionic member. The soil enhancement solution is configured to dehydrate an invasive plant by disturbing a water-retaining capacity of a number of cells of the invasive plant generate one or more beneficial nutrients; and deliver the beneficial nutrients to the soil.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “include” and “comprise” as well as derivatives thereof, mean inclusion without limitation. The term “or” is inclusive, meaning and/or. The phrase “associated with” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Definitions for other certain words and phrases are provided throughout this patent document. Those of ordinary skill in the art should understand that in many, if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example pre-treatment invasion area according to embodiments of the present disclosure;

FIG. 2 illustrates an example post-treatment invasion area according to embodiments of the present disclosure; and

FIG. 3 illustrates a process for forming a modular shoe system according to embodiments of the present disclosure.

### DETAILED DESCRIPTION

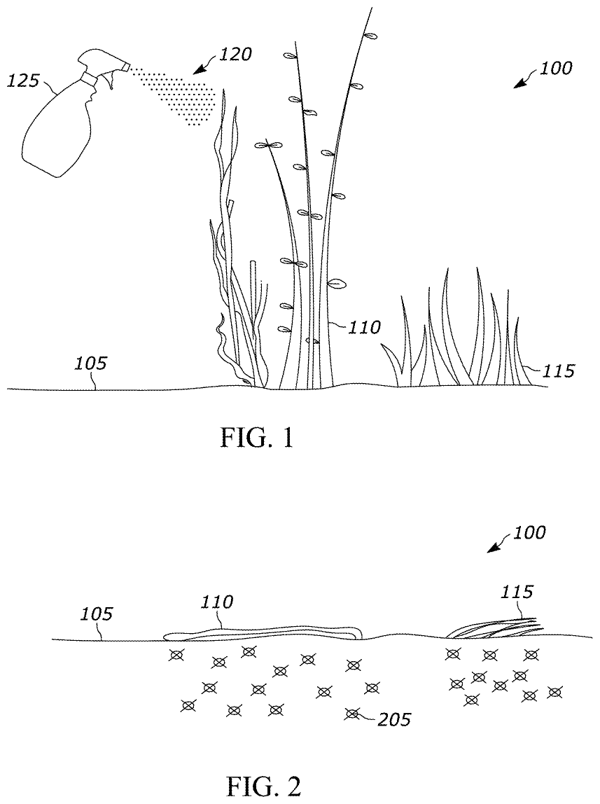

FIGS. 1 through 3, discussed below, and the various embodiments used to describe the principles of the present disclosure are by way of illustration only and should not be construed in any way to limit the scope of the disclosure. Those skilled in the art will understand that the principles of the present disclosure may be implemented in any suitably arranged system or device.

As noted above, a recent study for the National Association of Landscape Professionals revealed that 81% of Americans have a lawn. Many Americans further indicate that an attractive yard is an important feature of the home. Many yards suffer from infestation by non-desirable vegetation growth, commonly referred to as “weeds”. Some weeds include: Johnsongrass, dandelions, crabgrass, white clover, ragweed, chickweed, Creeping Charlie, Oxalis, Spotted spurge, bull thistle, quackgrass, and lambsquarter. These weeds are invasive and can be detrimental to the soil, grass, desired plant-life, and cattle. For example, Johnsongrass can generate cyanogenic glycosides, which is converted to free cyanide in the rumen in cattle. Additionally, thick Johnsongrass can alter the diversity of an area and alter soil properties due to associations with nitrogen-fixing bacteria.

Certain methods for weed control include applications of solutions including glyphosate. Glyphosate (C₃H₈NO₅P) is a widely used herbicide that inhibits plant growth by blocking an essential growth enzyme and interfering with a specific metabolic pathway. Glyphosate is listed as the active ingredient in ROUNDUP, which has been a very popular weed killer. ROUNDUP includes other ingredients in addition to Glyphosate. As noted above, ROUNDUP has been associated as a possible source of cancer in humans. For example, a few studies of farmers and people who work with ROUNDUP have linked the use of Glyphosate to non-Hodgkin lymphoma (a cancer originating in the white blood cells). Other studies have found no connection.

Glyphosate based herbicides often land on soil in areas adjacent to a treated plant. These Glyphosate based herbicides and their metabolites can persist in the soil and can further transfer to a proximate water source, such as groundwater, surface water, and water sediment. Additionally, wash-off from treated foliage and death and decay of Glyphosate treated plants can transfer the Glyphosate into the soil. The Glyphosate and its metabolites can further transfer into other, subsequently planted or adjacent non-treated plant-life. Certain studies have estimated that Glyphosate may have a half-life in soil between 7 and 60 days. Accordingly, Glyphosate mobility to proximate water sources and plant-life is high and can result in un-wanted exposure to toxic contaminants resulting from the Glyphosate and its metabolites.

Embodiments of the present disclosure provide a non-toxic acid-based solution that is able to penetrate leaf tissues and destroy protoplasm and chloroplast in cells of a plant on which the non-toxic acid-based solution is applied. Based on the application of the non-toxic acid-based solution, the plant dehydrates and dies. As the non-toxic acid-based solution reacts with the organic material of the plant, nutrients including sulfur and nitrogen are generated and deposited into the supporting soil. The resulting soil area is enhanced and ready to receive new plant-life within twenty-four hours of application of the non-toxic acid-based solution. Embodiments of the present disclosure provide an herbicidal solution that does not deposit harmful or toxic chemicals or compounds in the soil.

FIG. 1 illustrates an example pre-treatment invasion area according to embodiments of the present disclosure. The embodiment of the invasion area 100 shown in FIG. 1 is for illustration only. Other embodiments could be used without departing from the scope of the present disclosure.

The invasion area 100 includes soil 105 that comprises a loose surface material that covers most land. The soil 105 can include organic matter, minerals, and organisms, which are able to support life of plants and soil organisms. The soil 105 forms a base to support decorative grass and plants, including trees, shrubs, bushes, and the like. The soil 105 can provide a base to support different plant-life, including undesirable or invasive species, such as weeds 110. For example, one or more weeds 110 or un-wanted plants or grasses 115 may be growing in the invasion area 100.

In certain situations, it may be desirable to eliminate the weeds 110 or un-wanted plants or grasses 115. Therefore, a non-toxic acid-based solution 120 is applied as a non-selective herbicidal treatment. For example, a sprayer 125 can be used to apply the non-toxic acid-based solution 120 to the weeds 110 and/or un-wanted plants or grasses 115 in the invasion area 100. The sprayer 125 provides portability for applying the non-toxic acid-based solution 120 to selected different portions of the invasion area 100. Additionally, the non-toxic acid-based solution 120 can be delivered via a non-aerosol application, such as via a drip system, brush system, or the like. The application method can be configured to deliver the non-toxic acid-based solution 120 broadly or configured to target specific areas on a plant or group of plants. For example, the non-toxic acid-based solution 120 can be applied via a broad ranging spray, a narrow stream, or directly applied to portions of the plant-life.

The non-toxic acid-based solution 120 is configured to cause a reaction in the organic material in the plant-life causing the plant-life to die and decompose and produce enhancing nutrients, which are deposited into the soil. That is, the non-toxic acid-based solution 120 is configured to disrupt cell activity and destroy a cell integrity of the treated plant-life. For example, the non-toxic acid-based solution 120 can destroy cell walls causing the treated plant-life to dehydrate and die.

The non-toxic acid-based solution 120 includes an acid-based compound mixed with a non-ionic, silicone-based delivery agent and a non-ionic insulating element. Each of the components of the non-toxic acid-based solution 120 can be selected from elements that rapidly decompose, such as by organic or microbial decomposition, into non-toxic components. Accordingly, any resultant portion of the non-toxic acid-based solution 120 that reacts with organic material of the weeds 110 or un-wanted plants or grasses 115 and any portion of the non-toxic acid-based solution 120 that may be over-sprayed onto adjacent soil decomposes into elements that are non-toxic to animal or plant-life. For example, the non-toxic acid-based solution 120 can decompose into sulfate (SO₄²) which can quickly combine with calcium in the soil to form calcium-sulfate (CaSO₄²—namely, calcium salt or gypsum).

The acid-based compound can be composed from one or more of: sulfuric acid (H₂SO₄), chloric acid (HClO₃), acetic acid (CH₃COOH), orange oil (including limonene), or vinegar (CH₃COOH). In certain embodiments, the acid-based compound comprises a mixture of carbamide (CO(NH₂)₂), also referred to as urea, and sulfuric acid to produce urea-sulfuric. In certain embodiments, the acid-based compound is one of a mono-urea sulfuric, a di-urea sulfuric, or a urea-sulfate. The addition of carbamide to the acid can increase a pH (potential of Hydrogen) value of the acid-based compound. By increasing the pH of the acid-based compound, the potential for skin irritation of an individual applying the non-toxic acid-based solution 120 to the invasion area 100 is reduced.

The non-ionic, silicone-based delivery agent is configured to make the non-toxic acid-based solution 120 non-selective by carrying the acid-based compound through multiple different organic protective surfaces. In certain embodiments, the non-ionic, silicone-based delivery agent is configured to rapidly transport the non-toxic acid-based solution 120 through a protective barrier on the plant and into the cells of the treated plant-life. In certain embodiments, the non-toxic acid-based solution 120 is able to penetrate the protective barrier and deliver the non-toxic acid-based solution 120 into the plant-life within 2 minutes, inhibiting the potential for portions of the non-toxic acid-based solution 120 to be washed off the treated plant-life. In certain embodiments, the non-toxic acid-based solution 120 is able to penetrate the protective barrier and deliver the non-toxic acid-based solution 120 into the plant-life within 30 seconds. Therefore, the non-ionic, silicone-based delivery agent is configured to inhibit wash off and lack of terminal efficiency resulting from rain. The non-ionic, silicone-based delivery agent is further configured to deliver the non-toxic acid-based solution 120 into a wide range of plant-life, rendering the non-toxic acid-based solution 120 to be non-selective. The non-ionic, silicone-based delivery agent can be selected from one or more of: alkylphenol ethoxylate-based, alcohol-based, butanol, glycol, or silicone. In certain embodiments, the non-ionic, silicone-based delivery agent comprises a silicone surfactant having a polydimethylsiloxane and one of: polyether, alkanolamide, ester, or glycoside. In certain embodiments, the non-ionic, silicone-based delivery agent has a pH in a range of 5-8.

In certain embodiments, the non-ionic insulating element comprises a di-ionized (DI) water or distilled water. The non-ionic insulating element comprises a pure solution or element configured to insulate the acid-based compound from unwanted or unexpected reaction with unknown chemicals. In certain embodiments, the non-ionic insulating element has a pH greater than 6.

In certain embodiments, the non-toxic acid-based solution 120 comprises 25%-40% acid-based compound, 0.20%-40% non-ionic, silicone-based delivery agent, and 30%-50% insulating element. In certain embodiments, the non-toxic acid-based solution 120 comprises 35% acid-based compound, 25% non-ionic, silicone-based delivery agent, and 40% insulating element. In one example, the non-toxic acid-based solution 120 comprises 35% urea-sulfuric, 25% non-ionic, silicone-surfactant, and 40% DI water. In one example, the non-toxic acid-based solution 120 comprises 1 quart per 100 gallons of DI water (0.25% solution). In one example, the non-toxic acid-based solution 120 comprises 2 quarts per 100 gallons of DI water (0.50% solution). In one example, the non-toxic acid-based solution 120 comprises 3 quarts per 100 gallons of DI water (0.75% solution). In one example, the non-toxic acid-based solution 120 comprises 1 gallon per 100 gallons of DI water (1% solution).

Although FIG. 1 illustrates one example of an invasion area 100, various changes may be made to FIG. 1. For example, the invasion area 100 is shown in simplified form here and may include any number of additional dirts, soils, or plant-life, in any suitable configuration as needed or desired. Also, each component of the sprayer 125 may have any suitable size, shape, and dimensions and the non-toxic acid-based solution 120 may have different configurations or formulations as needed or desired.

FIG. 2 illustrates an example post-treatment invasion area according to embodiments of the present disclosure. The invasion area 100 shown in FIG. 2 is for illustration only. Other embodiments could be used without departing from the scope of the present disclosure.

As illustrated in the example depicted in FIG. 1, it may be desirable to eliminate certain grasses or plants from the invasion area 100 or eradicate all plant-life from the invasion area 100. To eliminate the unwanted plant-life, the non-toxic acid-based solution 120 is applied as a non-selective herbicidal treatment to the invasion area 100.

In the example shown in FIG. 2, the non-toxic acid-based solution 120 has been applied to the invasion area. The non-toxic acid-based solution 120 causes a reaction in the organic material in the plant-life causing the plant-life to die. The non-toxic acid-based solution 120 is non-selective, meaning that the non-toxic acid-based solution 120 causes most plant-life with which the non-toxic acid-based solution 120 comes in contact to die.

In certain embodiments, even though the non-toxic acid-based solution 120 is acid-based, compared to acetic acid, the non-toxic acid-based solution 120 is volatile organic compound (VOC) free. The acid is configured to attack the cells of the weeds 110 and/or un-wanted plants or grasses 115. For example, the acid can destroy the cell wall integrity of the treated weeds 110 and/or unwanted plants or grasses 115. As the acid destroys the cells, the water storage capacity of the cells. For example, the acid destroys the cell walls, protoplasm and chloroplast in cells. The protoplasm comprises 90-95% water. Accordingly, as the cells protoplasm is destroyed by the acid, the treated weeds 110 and/or un-wanted plants or grasses 115 dehydrate and die. The acid-based compound can be composed from one or more of: sulfuric acid (H₂SO₄), chloric acid (HClO₃), acetic acid (CH₃COOH), orange oil (including limonene), or vinegar (CH₃COOH). Acid is an irritant and can be very abrasive to skin. Accordingly, Urea is added to the acid to increase the pH value of the acid. The urea and acid are combined to form an acid-based compound. Upon reaction with the organic material, the acid-based compound and dead or dying plant material of the treated plants are either consumed by microbial material or organically decompose into enhancing nutrients such as sulfate, nitrogen, ammonium, and carbon dioxide. The enhancing nutrients can further combine with each other or with other materials in the soil, such as calcium, to adjust the pH value of the soil.

Many plants include a protective barrier, such as plant wax, which protects the plants from environmental stress. The protective barrier can include candelilla wax, carnauba wax, rice bran wax, as well as sunflower wax. In certain embodiments, the non-ionic, silicone-based delivery agent, such as a silicone surfactant, assists the acid-based compound by penetrating the plants resistance to absorbing the acid-based compound. The non-ionic refers to the surfactants' natural ionic charge, which aids in breaking up the surface tension of water or any other liquids that have been added to the solution to help them seep more thoroughly into the plant to which they are applied. The non-ionic, silicone-based delivery agent is configured to make the non-toxic acid-based solution 120 non-selective by carrying the acid-based compound through multiple different organic protective surfaces. In certain embodiments, the non-ionic, silicone-based delivery agent is configured to rapidly transport the non-toxic acid-based solution 120 through the protective barrier on the plant and into the cells of the treated plant-life. In certain embodiments, the non-toxic acid-based solution 120 is able to penetrate the protective barrier and deliver the non-toxic acid-based solution 120 into the plant-life within 10 minutes, inhibiting the potential for portions of the non-toxic acid-based solution 120 to be washed off the treated plant-life. Therefore, the non-ionic, silicone-based delivery agent is configured to inhibit wash off and lack of terminal efficiency resulting from rain. The non-ionic, silicone-based delivery agent is further configured to deliver the non-toxic acid-based solution 120 into a wide range of plant-life, rendering the non-toxic acid-based solution 120 to be non-selective. The non-ionic, silicone-based delivery agent can be selected from one or more of: alkylphenol ethoxylate-based, alcohol-based, butanol, glycol, or silicone.

Certain herbicides may include water as part of the solution. Water can contain one or more contaminants, such as hard minerals. For example, water may include one or more of: calcium, magnesium, iron, manganese, strontium, barium, zinc, and aluminum. The water may also contain sediment, nitrogen, bleach, salts, bacteria, toxins produced by bacteria, viruses, protozoa, and parasites. In certain situations, the water may also contain radiological contaminants such as cesium, plutonium, and uranium. One or more of these contaminants that may exist in a fluid may react with the acid-based compound or the non-ionic, silicone-based delivery agent and alter the effectiveness of either the herbicidal action or soil fertilization generation. For example, the calcium and magnesium can react with the acid in the solution, and reduce the effective portions of the acid or render the acid ineffective. In certain embodiments, the insulating agent, such as DI water, isolates the acid-based compound from unwanted reactions. The insulating agent is very pure and contains no contaminants that may react with either the acid-based compound or the non-ionic, silicone-based delivery agent. Since the insulating agent is very pure and contains no contaminants: (i) the non-ionic, silicone-based delivery agent is able to effectively penetrate the waxy resistance of the plant; (ii) the acid-based compound is able to effectively attack the water-retaining capacity of a number of cells of the treated plant; and (iii) the reaction of the acid-based compound with the organic material generates a fertilizing enhancing nutrients 205.

Within a first time period, one or more of the treated plant-life starts to experience a reaction with the non-toxic acid-based solution 120. For example, within four hours of application of the non-toxic acid-based solution 120, the non-toxic acid-based solution 120 dehydrates the treated plant-life. More particularly, upon contact with living material, the sulfuric acid in the urea-sulfuric disrupts the cell wall integrity, which releases the protoplasm and removes water from the cells in the plant-life. As water is removed from the cells, the cells die and, by extension, the treated plant dies. Within a second time period, the plant-life dies and an herbicidal function of the non-toxic acid-based solution 120 becomes inert. For example, within twenty-four hours, the weeds 110 and un-wanted plants or grasses 115 are dead. Additionally, within twenty-four hours, the herbicidal function of the non-toxic acid-based solution is inert allowing for the planting of new plant-life. That is, the acid-based compound organically decomposes into one or more elements as sulfate, nitrogen, ammonium, and carbon dioxide. Additionally, the decomposing plant life breaks down organically. Neither the decomposed plant material nor the decomposed elements of the non-toxic acid-based solution 120 is toxic or hazardous to proximate water, plant life, or animal life. That is, a remainder of the reaction between the non-toxic acid-based solution 120 and organic material in the weeds 110 and un-wanted plants or grasses 115 is inert and unable to dehydrate or kill any more organic material. Thereafter, one or more desired plants or grasses may be planted or seeded within the same soil 105 that had previously been treated with the non-toxic acid-based solution 120. Because the non-toxic acid-based solution 120 organically quickly and completely breaks down i, the newly planted or seeded plant-life does not include any of the non-toxic acid-based solution 120.

In certain embodiments, the reaction of the non-toxic acid-based solution 120 and the organic material in the plant-life causes a production of enhancing nutrients 205. In certain embodiments, the reaction of the urea-sulfuric creates enhancing nutrients 205 including one or more of: sulfate, ammonium, carbon dioxide ammonium sulfate, sulfur, or nitrogen. That is, the acid-based compound converts into a fertilizer for the soil 105. The enhancing nutrients 205 amend and improve the soil 105. The dead weeds 110 and dead and un-wanted plants or grasses 115 decompose and may add further fertilization to the proximate soil. Additionally, the enhancing nutrients 205 can react with one or more minerals in the enhancing nutrients 205 or soil. For example, the sulfate can combine with the ammonia to form Ammonium-Sulfate or react with Calcium in the soil to form Calcium-Sulfate or Gypsum. In certain embodiments, after the plant-life is dead or while the plant-life is dying, the soil 105 can be turned, such as be tilling, with or without the plant-life and new desirable plants or grasses may be planted. The non-toxic acid-based solution 120 is therefore configured to enable new plant-life to be planted shortly after treatment and further enhances or amending the soil 105.

Although FIG. 2 illustrates one example of a post-treatment invasion area 100, various changes may be made to FIG. 2. For example, the invasion area 100 is shown in simplified form here and may include any number of additional dirt(s), soils, or plant-life, in any suitable configuration as needed or desired. Also, the non-toxic acid-based solution 120 may have different configurations or formulations as needed or desired.

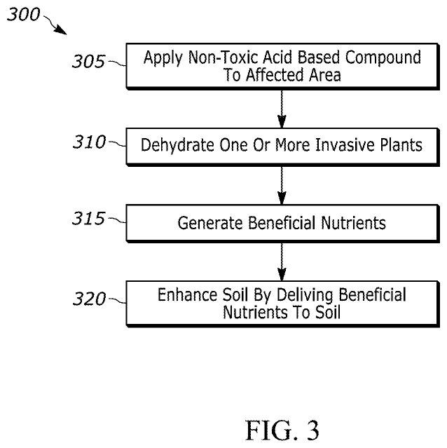

FIG. 3 illustrates a process 300 for forming a modular shoe system according to embodiments of the present disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps.

In operation 305, a non-toxic acid-based solution is applied to one or more invasive plants in a soil. The non-toxic acid-based solution can include urea-sulfuric, a non-ionic silicone surfactant, and DI water. The non-toxic acid-based solution is configured to eradicate the invasive plants while providing enhancing nutrients 205 to the soil. In operation 310, the non-toxic acid-based solution dehydrates the invasive plants by disturbing the cell-wall integrity and a corresponding water-retaining capacity of a number of cells of the invasive plants. In operation 315, the non-toxic acid-based solution generates one or more beneficial nutrients. In operation 320, the beneficial nutrients are delivered to the soil. The one or more beneficial nutrients can react with each to amend the soil, such as by adjusting a pH value of the soil. The one or more beneficial nutrients can reach with minerals in the soil to help the soil better absorb water or reduce erosion. For example, the non-toxic acid-based solution can organically decompose or separate to form sulfate, which combines with calcium in the soil form gypsum. Gypsum can assist with water absorption, inhibit erosion, and cut phosphorus movement from soils to lakes and streams. The beneficial nutrients include nitrogen, which is a major component of chlorophyll.

Although FIG. 3 illustrates one example of a process 300 for forming a modular shoe system, various changes may be made to FIG. 3. For example, while shown as a series of steps, various steps in FIG. 3 could overlap, occur in parallel, occur in a different order, or occur multiple times.

Although the present disclosure has been described with various embodiments, various changes and modifications may be suggested to one skilled in the art. It is intended that the present disclosure encompass such changes and modifications as falling within the scope of the claims.

The present disclosure should not be read as implying that any particular element, step, or function is an essential element, step, or function that must be included in the scope of the claims. Moreover, the claims are not intended to invoke 35 U.S.C. § 112 (f) unless the exact words “means for” are followed by a participle.

What is claimed is:

1. A soil enhancement method comprising:
applying non-toxic acid-based solution to one or more invasive plants in a soil;
dehydrating, by the non-toxic acid-based solution, the invasive plants by disturbing a water-retaining capacity of a number of cells of the invasive plants;
generating one or more beneficial nutrients; and
delivering the beneficial nutrients to the soil.

2. The method of claim 1, wherein the non-toxic acid-based solution comprises an acid-based compound, a non-ionic silicone-based delivery agent, and a non-ionic insulating element.

3. The method of claim 2, further comprising inhibiting a premature reaction of the acid-based compound prior to a reaction of the acid-based compound with organic material in the invasive plants.

4. The method of claim 2, wherein the acid-based compound composes 35% of the non-toxic acid-based solution,
wherein the non-ionic silicone-based delivery agent comprises a 0.75% surfactant, and
wherein the non-ionic insulating element composes 40% of the non-toxic acid-based solution.

5. The method of claim 2, wherein the acid-based compound comprises a combination of urea and sulfuric acid.

6. The method of claim 2, wherein the non-ionic silicone-based delivery agent comprises a silicone surfactant.

7. The method of claim 2, wherein the non-ionic insulating element comprises deionized water.

8. The method of claim 1, within four hours, terminating organic material in the invasive plants; and
rendering an herbicidal function of the non-toxic acid-based solution inert within twenty-four hours.

9. The method of claim 1, wherein the beneficial nutrients comprises one or more of: ammonium sulfate, sulfur, or nitrogen.

10. The method of claim 1, wherein the non-toxic acid-based solution is applied to the invasive plants via an aerosol application from a spray bottle.

11. A soil enhancement solution comprising:
a non-toxic acid-based solution configured to be applied to one or more invasive plants in a soil,
wherein the non-toxic acid-based solution is configured to:
dehydrate the invasive plants by disturbing a water-retaining capacity of a number of cells of the invasive plants;
generate one or more beneficial nutrients; and
deliver the beneficial nutrients to the soil.

12. The soil enhancement solution of claim 11, wherein the non-toxic acid-based solution comprises an acid-based compound, a non-ionic silicone-based delivery agent, and a non-ionic insulating element.

13. The soil enhancement solution of claim 12, wherein the non-ionic insulating element is configured to inhibit a premature reaction of the acid-based compound prior to a reaction of the acid-based compound with organic material in the invasive plants.

14. The soil enhancement solution of claim 12, wherein the non-toxic acid-based solution comprises, by volume:
35% of the acid-based compound,
25% of the non-ionic silicone-based delivery agent, and
40% of the non-ionic insulating element.

15. The soil enhancement solution of claim 12, wherein the acid-based compound comprises a combination of urea and sulfuric acid.

16. The soil enhancement solution of claim 12, wherein the non-ionic silicone-based delivery agent comprises a silicone surfactant.

17. The soil enhancement solution of claim 12, wherein the non-ionic insulating element comprises deionized water.

18. The soil enhancement solution of claim 11, wherein the non-toxic acid-based solution is configured to:
within four hours terminate organic material in the invasive plants; and
render the non-toxic acid-based solution inert within twenty-four hours.

19. The soil enhancement solution of claim 11, wherein the beneficial nutrients comprises one or more of: ammonium sulfate, sulfur, or nitrogen.

20. A soil enhancement solution comprising:
acid-based compound; and
a non-ionic member, wherein the soil enhancement solution is configured to:
dehydrate an invasive plant by disturbing a water-retaining capacity of a number of cells of the invasive plant;
generate one or more beneficial nutrients; and
deliver the beneficial nutrients to the soil.
